(19) United States
(12) Patent Application Publication
(10) Pub. No.: US 2023/0135477 A1
(43) Pub. Date: May 4, 2023

(54) SIGNAL TRANSFER SYSTEM, SIGNAL TRANSFER DEVICE, SIGNAL TRANSFER METHOD AND SIGNAL TRANSFER PROGRAM

(71) Applicant: NIPPON TELEGRAPH AND TELEPHONE CORPORATION, Tokyo (JP)

(72) Inventors: Naotaka SHIBATA, Musashino-shi, Tokyo (JP); Hiroko NOMURA, Musashino-shi, Tokyo (JP); Keita TAKAHASHI, Musashino-shi, Tokyo (JP); Tomoya HATANO, Musashino-shi, Tokyo (JP)

(73) Assignee: NIPPON TELEGRAPH AND TELEPHONE CORPORATION, Tokyo (JP)

(21) Appl. No.: 17/910,291

(22) PCT Filed: Mar. 9, 2020
(86) PCT No.: PCT/JP2020/010095

§ 371 Date: Sep. 8, 2022

(51) Int. Cl. H04W 72/23; H04W 88/08

(52) U.S. Cl. CPC H04W 72/23; H04W 88/08

(57) ABSTRACT

In a signal transfer system including a signal transfer management apparatus and a plurality of signal transfer apparatuses connected in multiple stages and forming a network between a distribution station apparatus and a central station apparatus, a signal transfer apparatus on an upper side among the plurality of signal transfer apparatuses transmits a timing adjustment request to at least one of a plurality of signal transfer apparatuses on a lower side when discard of a signal received from the plurality of signal transfer apparatuses on the lower side has been detected or when an amount of traffic of a plurality of signals received from the plurality of signal transfer apparatuses on the lower side exceeds a predetermined threshold value, and the signal transfer apparatus on the lower side that has received the timing adjustment request from the signal transfer apparatus on the upper side adjusts opening and closing timings of a gate based on the timing adjustment request. This can prevent the occurrence of a microburst.

### TECHNICAL FIELD

The present invention relates to a signal transfer technique that uses a time aware shaper (TAS) function.

### BACKGROUND ART

Networks that make up a cellular system include those of mobile fronthaul (MFH) and mobile backhaul (MBH). MBH is a network between distribution station apparatuses corresponding to base stations and a centralized station that controls the distribution station apparatuses. On the other hand, MFH corresponds to the section between a wireless control apparatus and wireless apparatuses when a base station is configured with its components deployed separately over the wireless control apparatus and the wireless apparatuses. In the related art, point-to-point connections have been used for this section, while implementation of a network with a configuration in which layer-2 switches are connected in multiple stages has also been considered (see NPL 1), which achieves efficient accommodation compared to point-to-point connections. In such networks, it is necessary to satisfy strict delay requirements, and in order to reduce the delay of high priority signals, it has been proposed that each signal transfer apparatus be equipped with a TAS function.

Hereinafter, the present invention will be described with reference to MBH as an example, but can also be applied to MFH by replacing distribution station apparatuses with wireless apparatuses and a central station apparatus with a wireless control apparatus.

### CITATION LIST

### Non Patent Literature

NPL 1: “Time-Sensitive Networking for Fronthaul,” IEEE Std P802. 1CM, May 7, 2018

### SUMMARY OF THE INVENTION

### Technical Problem

The TAS reserves a time slot for a high priority signal and opens a gate in the reserved time slot to transfer the signal while closing gates of other priority signals, such that high priority signals are transferred preferentially. However, simultaneously with the completion of transmission of a signal that is desired to be prioritized in control, the gate of a signal of another priority is opened and therefore if this occurs simultaneously at signal transfer apparatuses at multiple locations, signals of other priorities will simultaneously arrive at a signal transfer apparatus at the next stage where signals of a plurality of signal transfer apparatuses merge, such that there is a possibility that a microburst may occur. Similarly, at the time of occurrence of transmission of a signal that is desired to be prioritized in control, the gate of the signal that is desired to be prioritized is opened, but if this occurs simultaneously at signal transfer apparatuses at multiple locations, signals that are desired to be prioritized will simultaneously arrive at a signal transfer apparatus at the next stage where signals of a plurality of signal transfer apparatuses merge, such that there is a possibility that a microburst may occur.

Thus, in the MBH network, when gates are opened and closed simultaneously at a plurality of signal transfer apparatuses on the lower side, their signals will merge at a signal transfer apparatus on the upper side, such that a microburst occurs, causing a problem that signal delays and losses occur.

It is an object of the present invention to provide a signal transfer system, a signal transfer apparatus, a signal transfer method, and a signal transfer program wherein, upon detecting that a microburst has occurred, a signal transfer apparatus on the upper side instructs signal transfer apparatuses on the lower side to adjust the opening timings of gates, whereby it is possible to limit microbursts.

### Means for Solving the Problem

The present invention provides a signal transfer system including a distribution station apparatus corresponding to a wireless base station apparatus, a central station apparatus that centrally controls the wireless base station apparatus, a plurality of signal transfer apparatuses connected in multiple stages and forming a network between the distribution station apparatus and the central station apparatus, and a signal transfer management apparatus that controls the plurality of signal transfer apparatuses, wherein a signal transfer apparatus on an upper side among the plurality of signal transfer apparatuses transmits a timing adjustment request to at least one of a plurality of signal transfer apparatuses on a lower side among the plurality of signal transfer apparatuses when discard of a signal received from the plurality of signal transfer apparatuses on the lower side has been detected or when an amount of traffic of a plurality of signals received from the plurality of signal transfer apparatuses on the lower side exceeds a predetermined threshold value, and the signal transfer apparatus on the lower side that has received the timing adjustment request from the signal transfer apparatus on the upper side adjusts opening and closing timings of a gate based on the timing adjustment request.

The present invention also provides a signal transfer apparatus forming a network between a distribution station apparatus corresponding to a wireless base station apparatus, a central station apparatus that centrally controls the wireless base station apparatus, the distribution station apparatus, and the central station apparatus, the signal transfer apparatus including a signal distribution unit that distributes received signals to priority based buffers, a time gate unit that opens and closes gates for the signals of the buffers according to a command from a scheduler unit, a signal transfer unit that transfers frames output from the gates of the time gate unit to designated output destinations, and a discard detection unit that, when the signal transfer apparatus is a signal transfer apparatus on an upper side, monitors the signals of the buffers and transmits a timing adjustment request to at least one of a plurality of the signal transfer apparatuses on a lower side when discard of a signal received from the plurality of other signal transfer apparatuses on the lower side has been detected or when an amount of traffic of a plurality of signals received from the plurality of signal transfer apparatuses on the lower side exceeds a predetermined threshold value.

The present invention also provides a signal transfer method for a signal transfer system including a distribution station apparatus corresponding to a wireless base station apparatus, a central station apparatus that centrally controls the wireless base station apparatus, a plurality of signal transfer apparatuses connected in multiple stages and forming a network between the distribution station apparatus and the central station apparatus, and a signal transfer management apparatus that controls the plurality of signal transfer apparatuses, the signal transfer method including by a signal transfer apparatus on an upper side among the plurality of signal transfer apparatuses, transmitting a timing adjustment request to at least one of a plurality of signal transfer apparatuses on a lower side among the plurality of signal transfer apparatuses when discard of a signal received from the plurality of signal transfer apparatuses on the lower side has been detected or when an amount of traffic of a plurality of signals received from the plurality of signal transfer apparatuses on the lower side exceeds a predetermined threshold value, and by the signal transfer apparatus on the lower side that has received the timing adjustment request from the signal transfer apparatus on the upper side, adjusting opening and closing timings of a gate based on the timing adjustment request.

A signal transfer program according to the present invention causes a computer to execute processing performed in the signal transfer method.

### Effects of the Invention

The signal transfer system, the signal transfer apparatus, the signal transfer method, and the signal transfer program according to the present invention can limit microbursts because, upon detecting that a microburst has occurred, a signal transfer apparatus on the upper side instructs signal transfer apparatuses on the lower side to adjust the opening timings of gates.

### BRIEF DESCRIPTION OF DRAWINGS

FIG. 1 is a diagram illustrating an exemplary configuration of a signal transfer system common to each embodiment.

FIG. 2 is a diagram illustrating an exemplary configuration of a signal transfer apparatus on the upper side according to a first embodiment.

FIG. 3 is a diagram illustrating an exemplary configuration and operation of a signal transfer apparatus on the lower side.

FIG. 4 is a diagram illustrating an exemplary configuration of a signal transfer apparatus on the upper side according to a second embodiment.

FIG. 5 is a diagram illustrating an exemplary configuration of a signal transfer apparatus of a comparative example.

### DESCRIPTION OF EMBODIMENTS

Hereinafter, embodiments of a signal transfer system, a signal transfer apparatus, a signal transfer method, and a signal transfer program according to the present invention will be described with reference to the drawings. Each signal transfer apparatus described in the following embodiment corresponds to a network device such as a Layer-2 SWitch (L2SW) and the signal transfer management apparatus manages and controls the operation of signal transfer apparatuses.

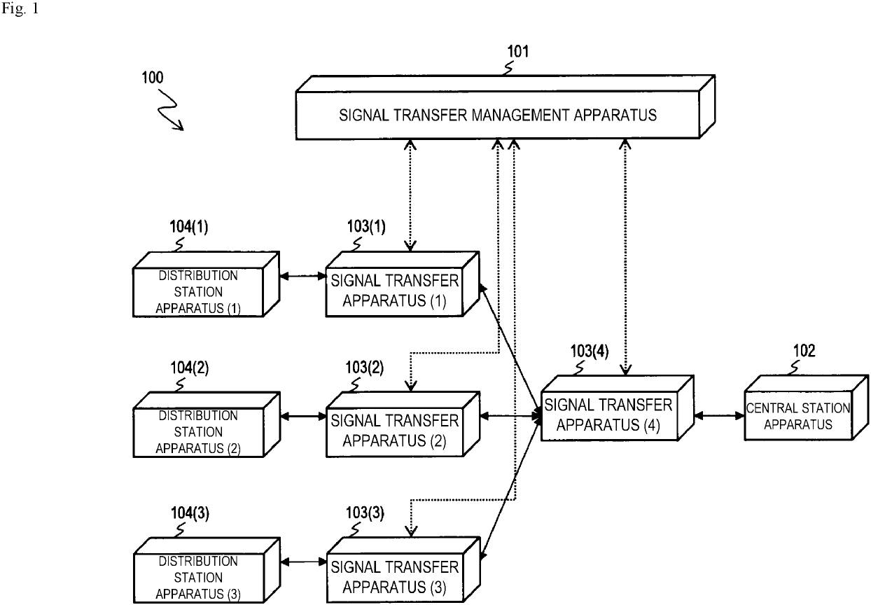

FIG. 1 illustrates an exemplary configuration of a signal transfer system 100 common to each embodiment. In FIG. 1, the signal transfer system 100 includes a signal transfer management apparatus 101, a central station apparatus 102, a signal transfer apparatus 103(1), a signal transfer apparatus 103(2), a signal transfer apparatus 103(3), a signal transfer apparatus 103 (4), a distribution station apparatus 104(1), a distribution station apparatus 104(2), and a distribution station apparatus 104(3). Here, when a common description is given on the signal transfer apparatuses 103(1) to 103(4) in the following description, each will be referred to as a signal transfer apparatus 103 with “(number)” at the end of the reference sign omitted and the same applies to the distribution station apparatus 104(1) to 104(3).

In the signal transfer system 100 illustrated in FIG. 1, a plurality of signal transfer apparatuses 103 connected in multiple stages form an MBH network between a plurality of distribution station apparatuses 104 and a central station apparatus 102 in a wireless base station apparatus that is deployed separately over the distribution station apparatuses 104 and the central station apparatus 102.

Here, the signal transfer apparatuses 103 are each equipped with a TAS function because signals communicated between the distribution station apparatuses 104 and the central station apparatus 102 are required to have a low delay. In the following description, signals communicated between distribution station apparatuses 104 and the central station apparatus 102 are referred to as frames when it is specifically indicated, while signals and frames basically indicate the same.

As described in the related art, the TAS reserves a time slot for a frame with traffic with a high priority (a high priority frame) and opens a gate in the reserved time slot to transfer the high priority frame while closing gates of frames with other priorities, such that high priority frames are transferred preferentially.

In FIG. 1, the distribution station apparatuses 104(1), 104(2), and 104(3) wirelessly communicate with wireless terminals (such as, for example, mobile terminals or IoT terminals) and high priority frames of communication signals are aggregated in the central station apparatus 102 via the MBH network formed of the signal transfer apparatuses 103(1) to 103(4).

The central station apparatus 102 aggregates uplink signals from the plurality of distribution station apparatuses 104 via the MBH network and distributes downlink signals to the distribution station apparatuses 104 via the MBH network.

The signal transfer apparatuses 103 are apparatuses that transfer signals between the distribution station apparatuses 104 and the central station apparatus 102 and form the MBH network. Although the network of FIG. 1 is illustrated as a star-type network, each embodiment can be similarly applied to a ring-type network, a mesh-type network, or the like.

Here, in the following description, one side of the plurality of signal transfer apparatuses 103 connected in multiple stages which is closer to the distribution station apparatuses 104 is referred to as a lower side and the other side which is closer to the central station apparatus 102 is referred to as an upper side. Further, in the direction in which a signal flows, a stage from which the signal is transmitted is referred to as a previous stage and another stage at which the signal is received is referred to as a next stage. For example, in the case of FIG. 1, the signal transfer apparatuses 103(1), 103(2), and 103(3) are each a signal transfer apparatus 103 on the lower side in the uplink direction from the distribution station apparatuses 104 to the central station apparatus 102 and are each a signal transfer apparatus 103 at the previous stage with respect to the signal transfer apparatus 103(4). Similarly, the signal transfer apparatus 103(4) is a signal transfer apparatus 103 on the upper side and a signal transfer apparatus 103 at the next stage to the signal transfer apparatuses 103(1), 103(2), and 103(3).

The example of FIG. 1 is provided with the signal transfer apparatuses 103(1), 103(2), and 103(3) on the lower side which are connected respectively to the distribution station apparatuses 104(1), 104(2), and 104(3) and the signal transfer apparatus 103(4) on the upper side that aggregates signals from the signal transfer apparatuses 103(1) to 103(3) and connects them to the central station apparatus 102. In the present embodiment, the signal transfer apparatus 103(4) on the upper side among the plurality of signal transfer apparatuses 103 transmits a timing adjustment request to at least one of a plurality of signal transfer apparatuses 103 on the lower side in the following two cases. The first is the case where a signal received from the plurality of signal transfer apparatuses 103 on the lower side (103(1), 103(2) and 103(3)) has been discarded. The second is the case where the amount of traffic of a plurality of signals received from the plurality of signal transfer apparatuses 103 on the lower side exceeds a predetermined threshold value. Then, a signal transfer apparatus 103 on the lower side, which has received a timing adjustment request from the signal transfer apparatus 103(4) on the upper side, adjusts the opening and closing timings of gates based on the timing adjustment request. Here, a timing adjustment request is control information for adjusting the opening and closing timings of gates. The opening timing of a gate of a priority corresponding to a signal that causes a microburst is shifted backward by a designated interval to delay the transmission timing of the signal. Here, the closing timing of the gate may be shifted backward by the designated interval or may remain unchanged without being shifted. The control information includes information on the designated interval and the designated interval corresponds to the amount of delay that will be described later.

In FIG. 1, the signal transfer management apparatus 101 determines paths through which signals are to be passed between the distribution station apparatuses 104 and the central station apparatus 102 in the network formed of the signal transfer apparatuses 103 and instructs each signal transfer apparatus 103 or instructs a scheduler unit 205 in each signal transfer apparatus 103.

As described above, in the signal transfer system 100 according to each embodiment, a signal transfer apparatus 103 on the upper side monitors signals received from a plurality of signal transfer apparatuses 103 on the lower side and transmits a timing adjustment request to at least one of the plurality of signal transfer apparatuses 103 on the lower side when a signal received from the plurality of signal transfer apparatuses 103 on the lower side has been discarded or when the amount of traffic of a plurality of signals received from the plurality of signal transfer apparatuses 103 on the lower side exceeds a predetermined threshold value. Then, a signal transfer apparatus 103 on the lower side, which has received a timing adjustment request from the signal transfer apparatus 103 on the upper side, adjusts the opening and closing timings of gates based on the timing adjustment request. Thereby, it is possible to prevent the occurrence of a microburst.

### First Embodiment

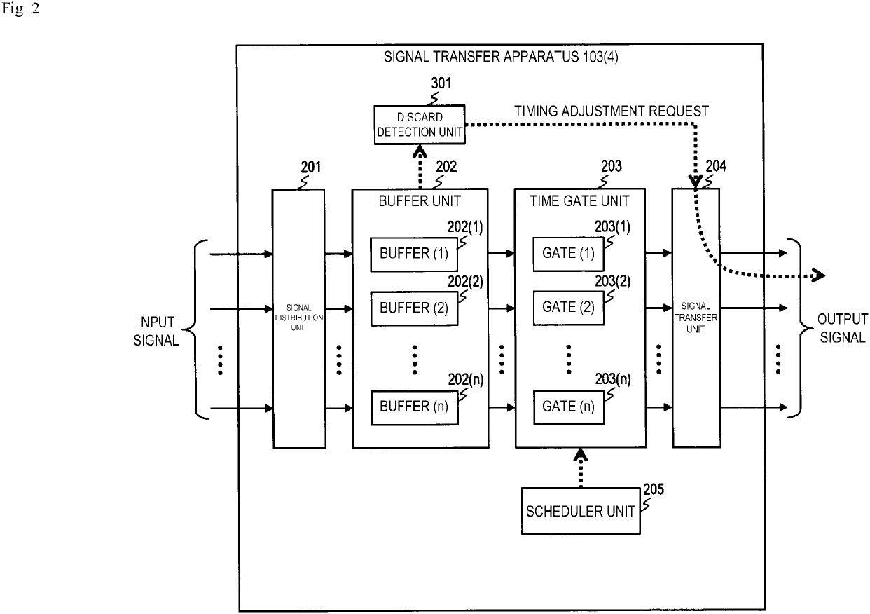

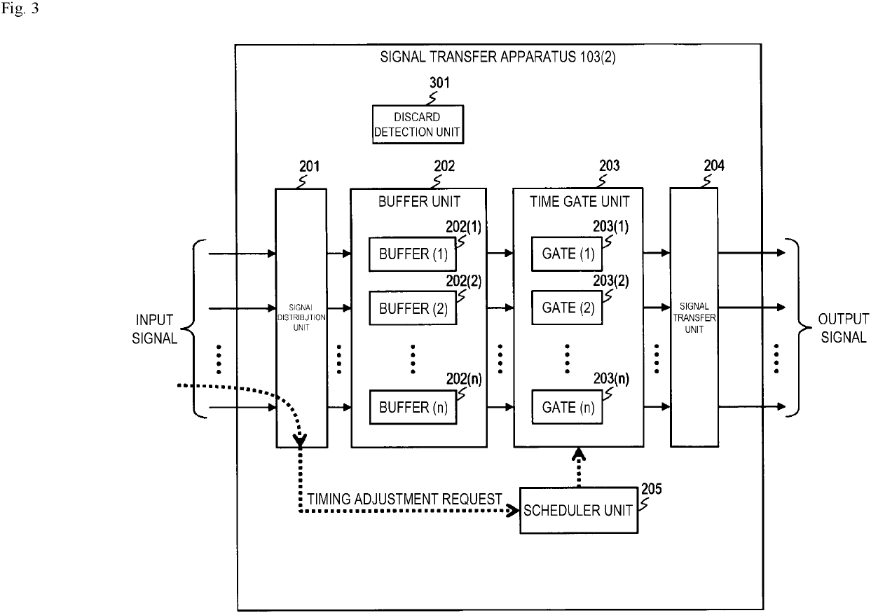

FIG. 2 illustrates an exemplary configuration of a signal transfer apparatus 103 on the upper side according to a first embodiment. In particular, FIG. 2 illustrates an exemplary configuration and operation of the signal transfer apparatus 103(4) illustrated in FIG. 1 as a signal transfer apparatus 103 on the upper side. An exemplary configuration and operation of the signal transfer apparatus 103 on the lower side (the signal transfer apparatus 103(1), 103(2) or 103(3) illustrated in FIG. 1) will be described with reference to FIG. 3. Here, the configurations of the signal transfer apparatus 103 on the upper side and the signal transfer apparatus 103 on the lower side are the same, but the operations thereof are different.

In FIG. 2, the signal transfer apparatus 103(4) includes a signal distribution unit 201, a buffer unit 202, a time gate unit 203, a signal transfer unit 204, a scheduler unit 205, and a discard detection unit 301.

The signal distribution unit 201 has a function of distributing input signals to priority based buffers. For example, the signal distribution unit 201 distributes frames, which are received from a distribution station apparatus 104 or another signal transfer apparatus 103 when they are uplink or received from the central station apparatus 102 or another signal transfer apparatus 103 when they are downlink, based on priorities stored in their frame headers and outputs them to the buffer unit 202. In the present embodiment, the signal distribution unit 201 also receives control information such as a timing adjustment request output from another signal transfer apparatus 103 and outputs the control information to the scheduler unit 205 and the like.

The buffer unit 202 is a buffer memory that temporarily holds high priority frames or low priority frames distributed by the signal distribution unit 201 according to their priorities. The buffer unit 202 includes a plurality of preset priority based buffers (such as, for example, high priority buffers and low priority buffers). In the example of FIG. 2, the buffer unit 202 includes n buffers 202(1), 202(2), ..., and 202(n) (where n is a positive integer).

The time gate unit 203 includes a plurality of gates corresponding to the plurality of buffers of the buffer unit 202 and opens and closes the gates in response to commands from the scheduler unit 205. In the example of FIG. 2, the time gate unit 203 includes n gates 203(1), 203(2), ..., 203(n). The time gate unit 203 controls opening and closing of the gates that output frames from the corresponding buffers in which the frames with corresponding priorities are held, for example, in response to commands from the scheduler unit 205.

The signal transfer unit 204 has a function of transferring frames output from the gates of the time gate unit 203 to output destinations designated based on commands from the signal transfer management apparatus 101 that will be described later. In the present embodiment, the signal transfer unit 204 also has a function of transferring control information such as a timing adjustment request to another signal transfer apparatus 103 while transferring frames.

The scheduler unit 205 controls whether to transmit signals held in the buffers of the buffer unit 202 by opening and closing the gates of the time gate unit 203 based on preset scheduling information. Here, the scheduling information is information regarding gate start times, gate open durations, gate opening cycles, or the like of the gates of the time gate unit 203 for the frames held in the priority based buffers of the buffer unit 202. Here, in the present embodiment, the scheduling information of the scheduler unit 205 is adjusted based on a calculation result of the calculation unit 206. When the scheduling information is not adjusted, the scheduler unit 205 periodically opens and closes each gate at a gate start time, a gate open duration, and a gate opening cycle that are predetermined according to the priority.

The discard detection unit 301 has a function of monitoring signals of the buffer unit 202 and detecting discard of a frame due to the occurrence of a microburst or the like. Upon detecting discard of a frame in the buffer unit 202, the discard detection unit 301 determines that a microburst has occurred and transmits a timing adjustment request to a signal transfer apparatus 103 at the previous stage. When there are a plurality of signal transfer apparatuses 103 at the previous stage, the discard detection unit 301 transmits a timing adjustment request to at least one or more of the plurality of signal transfer apparatuses 103. As described above, a timing adjustment request is control information for shifting the opening interval of the gate of a signal of a priority corresponding to a signal that causes a microburst backward by a designated interval to delay the transmission timing of the signal, such that it is possible to avoid the concentration of signals in the signal transfer apparatus 103 at the next stage.

In the signal transfer system 100 according to the present embodiment, upon detecting discard of a frame, a signal transfer apparatus 103(4) on the upper side determines that a microburst has occurred and transmits a timing adjustment request to at least one of the signal transfer apparatuses 103(1) to 103(3) on the lower side. Then, the scheduler unit 205 of each signal transfer apparatus 103 on the lower side receives a timing adjustment request from the signal transfer apparatus 103 on the upper side or the central station apparatus 102 and adjusts the opening and closing timings of gates. When a timing adjustment request is made to a plurality of signal transfer apparatuses 103, it is necessary to change the amount of delay requested to each signal transfer apparatus 103. In a method of determining the amount of delay, for example, a correspondence table between the amount of traffic and the amount of delay may be created in advance and set in the scheduler unit 205. This is due to the need to increase the amount of delay as the amount of traffic increases. Alternatively, the amount of delay may be set as a sufficiently small initial value and the timing may then be adjusted by increasing the amount of delay little by little over a plurality of times until there is no discarded frame.

In the signal transfer system 100 according to the present embodiment, upon detecting discard of a frame, a signal transfer apparatus 103 at the next or later stage determines that a microburst has occurred and makes a timing adjustment request to a signal transfer apparatus 103 at the previous stage, whereby it is possible to limit the occurrence of microbursts as described above.

FIG. 3 illustrates an exemplary configuration and operation of the signal transfer apparatus 103(2) on the lower side. Blocks in FIG. 3 with the same reference signs as those of FIG. 2 have the same functions as those of FIG. 2. Although the case with the signal transfer apparatus 103(2) will be described with reference to FIG. 3, the signal transfer apparatuses 103(1) and 103(3) on the lower side of the signal transfer apparatus 103(4) operate in the same manner as the signal transfer apparatus 103(2).

In FIG. 3, a signal distribution unit 201, a buffer unit 202, a time gate unit 203, and a signal transfer unit 204 operate in the same manner as those of the signal transfer apparatus 103(4) described with reference to FIG. 2. In FIG. 3, the operation of a discard detection unit 301 is omitted. However, when another signal transfer apparatus 103 is connected to the signal transfer apparatus 103(2) at the previous stage with respect to the signal transfer apparatus 103(2), the discard detection unit 301 in FIG. 3 operates in the same manner as the discard detection unit 301 of the signal transfer apparatus 103(4) described with reference to FIG. 2. Then, when discard of a frame has been detected, the signal transfer system 100 determines that a microburst has occurred and transmits a timing adjustment request to the other signal transfer apparatus 103 at the previous stage.

In FIG. 3, the signal transfer apparatus 103(2) receives a timing adjustment request from the signal transfer apparatus 103(4) on the upper side described with reference to FIG. 2 and the timing adjustment request is input to the scheduler unit 205 through the signal distribution unit 201.

The scheduler unit 205 adjusts scheduling information based on the timing adjustment request received from the signal transfer apparatus 103(4) at the next stage. The scheduling information is adjusted, for example, such that the opening interval of the gate of a signal of a priority corresponding to a signal that causes a microburst is shifted backward by an amount of delay included in the timing adjustment request to delay the transmission timing of the signal. Thereby, it is possible to avoid the concentration of signals in the signal transfer apparatus 103 at the next stage. When the scheduling information is not adjusted, the scheduler unit 205 periodically opens and closes each gate at a gate start time, a gate open duration, and a gate opening cycle that are predetermined according to the priority.

In this way, a signal transfer apparatus 103 at the previous stage according to the present embodiment receives a timing adjustment request transmitted from a signal transfer apparatus 103 at the next or later stage and adjusts scheduling information based on the timing adjustment request, whereby it is possible to limit the occurrence of microbursts in the signal transfer apparatus 103 at the next or later stage.

### Second Embodiment

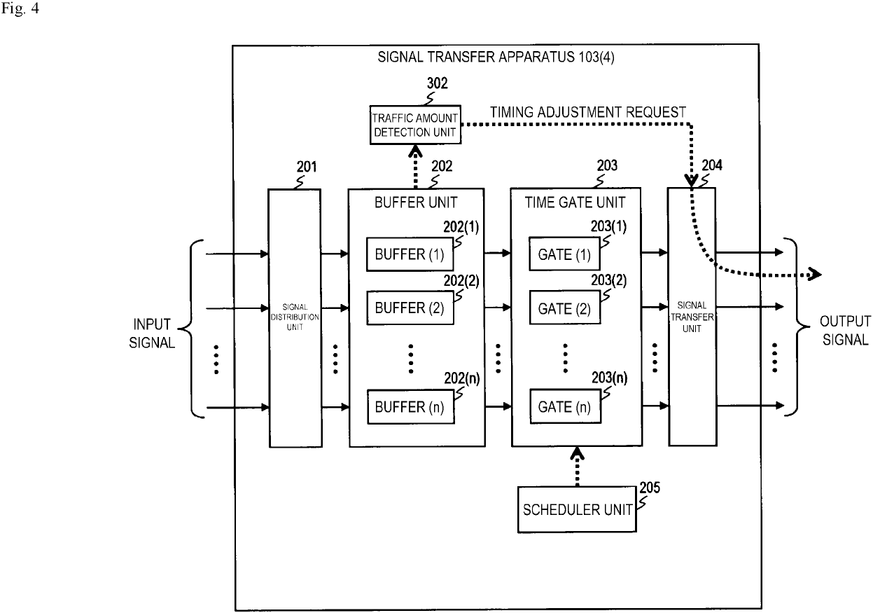

FIG. 4 illustrates an exemplary configuration of a signal transfer apparatus 103 on the upper side according to a second embodiment. In particular, similar to FIG. 2, FIG. 4 illustrates an exemplary configuration and operation of the signal transfer apparatus 103(4) illustrated in FIG. 1 as a signal transfer apparatus 103 on the upper side.

In FIG. 4, the signal transfer apparatus 103(4) includes a traffic amount detection unit 302 instead of the discard detection unit 301 of the signal transfer apparatus 103(4) of FIG. 2. The operations of a signal distribution unit 201, a buffer unit 202, a time gate unit 203, a signal transfer unit 204, and a scheduler unit 205, other than the traffic amount detection unit 302, are similar to those of the signal transfer apparatus 103 according to the first embodiment.

In FIG. 4, when the amount of traffic in the buffer unit 202 exceeds a preset threshold value, the traffic amount detection unit 302 determines that a microburst has occurred due to congestion and transmits a timing adjustment request to a signal transfer apparatus 103 at the previous stage. When there are a plurality of signal transfer apparatuses 103 at the previous stage, a timing adjustment request is transmitted to at least one or more of the plurality of signal transfer apparatuses 103. Here, similar to the first embodiment, a timing adjustment request is control information for shifting the opening interval of the gate of a signal of a priority corresponding to a signal that causes a microburst backward by a designated interval to delay the transmission timing of the signal, such that it is possible to avoid the concentration of signals in the signal transfer apparatus 103 at the next or later stage.

In this way, when a microburst has occurred in a signal transfer apparatus 103 at the next or later stage, the signal transfer apparatus 103 at the next or later stage makes a timing adjustment request to signal transfer apparatuses 103 at the previous stage, whereby it is possible to limit the occurrence of microbursts.

The operation of each signal transfer apparatus 103 on the lower side is similar to that of the signal transfer apparatus 103(2) according to the first embodiment described with reference to FIG. 3.

### Comparative Example

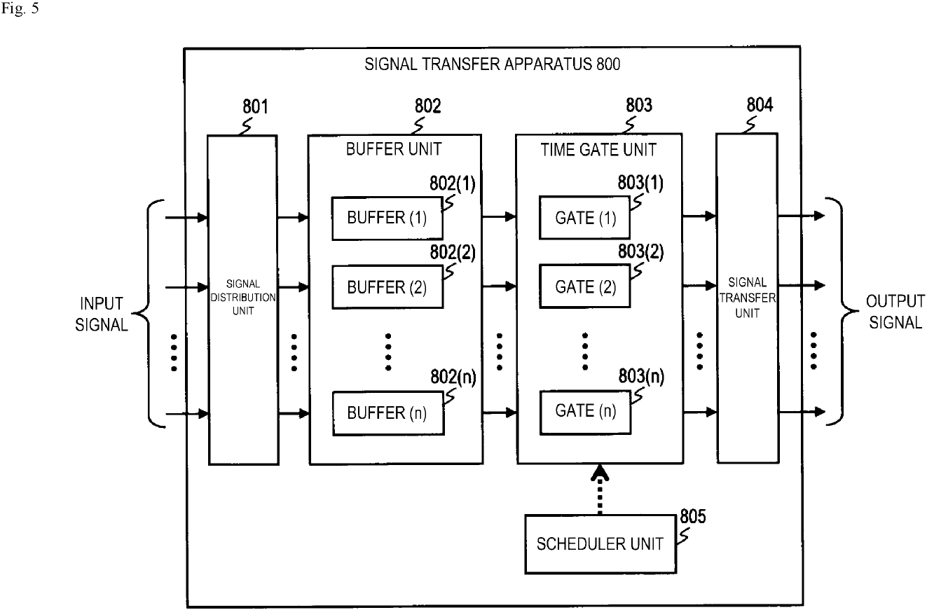

FIG. 5 illustrates an exemplary configuration of a signal transfer apparatus 800 of a comparative example. In FIG. 5, the signal transfer apparatus 800 includes a signal distribution unit 801, a buffer unit 802, a time gate unit 803, a signal transfer unit 804, and a scheduler unit 805. The signal transfer apparatus 800 has a TAS function and controls the opening and closing of each gate according to the priority.

Similar to the signal distribution unit 201 according to each embodiment, the signal distribution unit 801 has a function of distributing input signals to priority based buffers.

Similar to the buffer unit 202 according to each embodiment, the buffer unit 802 is a buffer memory that temporarily holds high priority frames or low priority frames distributed by the signal distribution unit 801 according to their priorities. In the example of FIG. 5, the buffer unit 802 has n buffers 802(1), 802(2), ..., 802(n).

Similar to the time gate unit 203 according to the present embodiment, the time gate unit 803 includes a plurality of gates corresponding to the plurality of buffers of the buffer unit 802 and opens and closes the gates in response to commands from the scheduler unit 805. In the example of FIG. 5, the time gate unit 803 has n gates 803(1), 803(2), ..., 803(n).

The signal transfer unit 804 has a function of transferring frames output from the gates of the time gate unit 803 to output destinations designated by the signal transfer management apparatus 101.

The scheduler unit 805 periodically opens and closes each gate at the gate start time, the gate open duration, and the gate opening cycle according to the priority based on predetermined scheduling information and preferentially transfers high priority frames.

Thus, through the TAS function, the signal transfer apparatus 800 reserves a time slot for a high priority frame and opens a gate in the reserved time slot to transfer the high priority frame while closing the gates of other priority frames, such that high priority frames can be transferred preferentially. However, in the comparative example, simultaneously with the completion of transmission of a frame that is desired to be prioritized in control, an event occurs where the gate of a frame of another priority is opened. Therefore, if this event occurs simultaneously at signal transfer apparatuses 800 at multiple locations, frames of other priorities will simultaneously arrive at a signal transfer apparatus 800 on the upper side, such that there is a possibility that a microburst may occur. Similarly, at the time of occurrence of transmission of a signal that is desired to be prioritized in control, an event occurs where the gate of the signal that is desired to be prioritized is opened. If this event occurs simultaneously at signal transfer apparatuses at multiple locations, signals that are desired to be prioritized will simultaneously arrive at a signal transfer apparatus at the next stage where signals of a plurality of signal transfer apparatuses merge, such that there is a possibility that a microburst may occur.

On the other hand, in the signal transfer system, the signal transfer apparatus, the signal transfer method, and the signal transfer program according to the present invention, when discard of a frame has been detected or when the amount of traffic exceeds a preset threshold value, a signal transfer apparatus on the upper side determines that a microburst has occurred and instructs signal transfer apparatuses on the lower side to adjust the opening timings of gates, whereby it is possible to limit microbursts as described in each embodiment.

Although each embodiment has been described assuming that it is applied to MBH, it can also be applied to MFH. In the case of MFH, the distribution station apparatuses are replaced with wireless apparatuses and the central station apparatus is replaced with a wireless control apparatus, and the wireless apparatuses and the wireless control apparatus share and execute the functions of one base station.

Here, a signal transfer apparatus 103 according to each embodiment has been described with reference to apparatuses with blocks illustrated in FIGS. 2, 3, and 4, but it can also be realized by a computer that executes a program of a signal transfer method corresponding to processing performed by each block. The program may be recorded on a recording medium to be provided or may be provided through a network.

Reference Signs List
100 Signal transfer system
101 Signal transfer management apparatus
102 Central station apparatus
103, 800 Signal transfer apparatus
104 Distribution station apparatus
201, 801 Signal distribution unit
202, 802 Buffer unit
203, 803 Time gate unit
204, 804 Signal transfer unit
205, 805 Scheduler unit
206 Calculation unit
251 Cooperation interface
301 Discard detection unit
302 Traffic amount detection unit

1. A signal transfer system comprising:
a distribution station apparatus corresponding to a wireless base station apparatus;
a central station apparatus configured to centrally control the wireless base station apparatus;
a plurality of signal transfer apparatuses connected in multiple stages and forming a network between the distribution station apparatus and the central station apparatus; and
a signal transfer management apparatus configured to control the plurality of signal transfer apparatuses, wherein
a signal transfer apparatus on an upper side among the plurality of signal transfer apparatuses is configured to transmit a timing adjustment request to at least one of a plurality of signal transfer apparatuses on a lower side among the plurality of signal transfer apparatuses when discard of a signal received from the plurality of signal transfer apparatuses on the lower side has been detected or when an amount of traffic of a plurality of signals received from the plurality of signal transfer apparatuses on the lower side exceeds a predetermined threshold value, and
the signal transfer apparatus on the lower side that has received the timing adjustment request from the signal transfer apparatus on the upper side is configured to adjust opening and closing timings of a gate based on the timing adjustment request.

2. The signal transfer system according to claim 1, wherein the timing adjustment request is control information for shifting an opening interval of a gate of a priority signal other than a high priority signal backward by a designated interval to delay a transmission timing of the other priority signal or control information for shifting an opening interval of a gate of the high priority signal backward by a designated interval to delay a transmission timing of the high priority signal.

3. A signal transfer apparatus forming a network between a distribution station apparatus corresponding to a wireless base station apparatus, a central station apparatus configured to centrally control the wireless base station apparatus, the distribution station apparatus, and the central station apparatus, the signal transfer apparatus comprising:
a signal distribution unit configured to distribute received signals to priority based buffers;
a time gate unit configured to open and close gates for the signals of the buffers according to a command from a scheduler unit;
a signal transfer unit configured to transfer frames output from the gates of the time gate unit to designated output destinations; and
a discard detection unit configured to, when the signal transfer apparatus is a signal transfer apparatus on an upper side, monitor the signals of the buffers and transmit a timing adjustment request to at least one of a plurality of the signal transfer apparatuses on a lower side when discard of a signal received from the plurality of other signal transfer apparatuses on the lower side has been detected or when an amount of traffic of a plurality of signals received from the plurality of signal transfer apparatuses on the lower side exceeds a predetermined threshold value.

4. The signal transfer apparatus according to claim 3, wherein the timing adjustment request is control information for shifting an opening interval of a gate of a priority signal other than a high priority signal backward by a designated interval to delay a transmission timing of the other priority signal or control information for shifting an opening interval of a gate of the high priority signal backward by a designated interval to delay a transmission timing of the high priority signal.

5. A signal transfer method for a signal transfer system including a distribution station apparatus corresponding to a wireless base station apparatus, a central station apparatus configured to centrally control the wireless base station apparatus, a plurality of signal transfer apparatuses connected in multiple stages and forming a network between the distribution station apparatus and the central station apparatus, and a signal transfer management apparatus configured to control the plurality of signal transfer apparatuses, the signal transfer method comprising:
by a signal transfer apparatus on an upper side among the plurality of signal transfer apparatuses, transmitting a timing adjustment request to at least one of a plurality of signal transfer apparatuses on a lower side among the plurality of signal transfer apparatuses when discard of a signal received from the plurality of signal transfer apparatuses on the lower side has been detected or when an amount of traffic of a plurality of signals received from the plurality of signal transfer apparatuses on the lower side exceeds a predetermined threshold value, and
by the signal transfer apparatus on the lower side that has received the timing adjustment request from the signal transfer apparatus on the upper side, adjusting opening and closing timings of a gate based on the timing adjustment request.

6. The signal transfer method according to claim 5, wherein
the timing adjustment request is control information for shifting an opening interval of a gate of a priority signal other than a high priority signal backward by a designated interval to delay a transmission timing of the other priority signal or control information for shifting an opening interval of a gate of the high priority signal backward by a designated interval to delay a transmission timing of the high priority signal.

7. A non-transitory computer-readable medium having computer-executable instructions that, upon execution of the instructions by a processor of a computer, cause the computer to function as the signal transfer method according to claim 5 .
